(19) United States
(12) Patent Application Publication
(10) Pub. No.: US 2009/0240703 A1
(43) Pub. Date: Sep. 24, 2009

(54) INTERESTING INFORMATION CREATION METHOD FOR REGISTERED CONTENTS, CONTENTS STOCK SERVER, CONTENTS INFORMATION MANAGEMENT SERVER AND INTERESTING INFORMATION CREATING SYSTEM FOR REGISTERED CONTENTS

(75) Inventor: Tatsuo YOSHINO, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/408,359

(22) Filed: Mar. 20, 2009

(30) Foreign Application Priority Data
Mar. 21, 2008 (JP) 2008-074480

(51) Int. Cl. G06F 3/048; G06F 17/30

(52) U.S. Cl. 707/10; 715/765; 707/E17.032

(57) ABSTRACT

One of the objects of the present invention is to provide a service system that can decide the equivalent value according to the record of using the contents by increasing not only a simple charge for using the contents but also the contents utility value and utilization rate, and collect the information for deciding the charge for using the added value valid for both the service provider and the service user to be higher for the service provider and cheaper for the service user.

### BACKGROUND OF THE INVENTION

1. Field of the Invention

The present invention relates to a technique for providing the useful information in distributing the information corresponding to various kinds of contents.

2. Description of the Related Art

In recent years, the photograph or illustration is provided to the reader in the high quality image through the medium of not only the paper medium but also the Web page. Also, the motion picture has started to be popular as the Web medium as well. Especially for the contents for use in advertisement that convey the image that the advertiser wants to convey to the consumer, the cameraman or creator is asked to photograph or produce the contents according to the image, or the already photographed contents are found and used.

To meet this series of needs, a contents stock business service for collecting, storing and managing a large amount of contents or mediating between the cameraman/creator and the advertiser has been provided.

Particularly with the recent trend of digitization of the contents, a contents stock agency starts up a contents stock sever, digitizes and stores a large amount of photographs that exist before as the digital image, and also stores the contents photographed by a digital device such as a digital camera or the contents produced by a PC or the like as the digital image.

And the contents stock service agency collects the contents according to the demands of the advertiser and the advertiser prepares a search environment where it is easy to peruse the contents to enhance the convenience, thereby offering the better services by providing the contents stored in the contents stock server to the user (e.g., advertiser).

Recently, with the spread of the digital machinery and materials such as a digital camera and the internet, and the development of the image processing technology, anyone can photograph the high quality contents and simply upload them to a photo stock server.

Also, it is possible to distribute the information on a demand of the user (advertiser) via the internet instantaneously, and convey the contents according to the demand to the cameraman or creator to acquire the contents from anywhere in the world (upload the contents to the contents stock server). Though the specified cameraman is conventionally asked to take the photograph, another method of conveying the demand to an unspecified large number of cameramen to call for photographing, and selecting the favorite contents from may be adopted.

Also, a contents service called a micro payment photo stock service has recently widespread. This is a business form of selling the necessary contents by the piece at a small sum from various kinds of contents with the photographic contents as the main. More specifically, with the spread of the internet, this is a service form of providing an occasion of uploading the photographic contents to an unspecified large number of cameramen in which the photo stock service agency mediates between the user (advertiser) and the photographic contents holder (photographer, producer, or copyright holder).

The contents provider (cameraman/producer) can earn an income by selling (or licensing) the consents, if the contents that may not be famous but is matched with the demand of the advertiser can be provided. There is a merit that the advertiser can rapidly acquire the contents according to the demand at a low cost.

The advertiser not only prints the purchased or licensed contents on the paper medium for advertisement, but also recently uses the contents on the Web medium to provide the information having high added value, whereby there is a desire for an information providing method having higher added value in the future.

Also, an advertisement method in a new form such as word-of-mouth advertising in the blog or the like has been recently conducted. The contents stock as a material for blog can be considered in a service form inexistent before.

Also, the net auction photograph becomes a very convenient service if the high quality photograph is sought and a high information link function can be provided.

One example of the photo stock service was described in “Riya Visual Search”, [online], [Search on Jan. 16, 2008], internet <URL:http://www.riva.com/>. Herein, the user uploads the photograph to the server, whereby an unspecified large number of persons or the service members can enjoy in looking at the uploaded photograph by setting.

To enhance the convenience of the photograph sharing type service, each user can register a keyword as the tag data to increase the ability of searching one's own (other's) photograph from all the photographic images in the typical photograph sharing type service.

In this service, each user further can designate a subject on the photograph by a rectangular area, and give the tag data to each area designated by the rectangular area. It is possible to enhance the convenience of searching the subject on the photograph by giving the tag data to each of the subjects on the photograph.

For example, by clicking in an interest area, the other photograph can be searched based on the tag data registered within the interest area.

### SUMMARY OF THE INVENTION

With the prior art as described above, an object area is specified beforehand and the simple search tag information is attached to it, whereby it is unknown where in the photograph the reader is specifically interested in, and because the operation can be made using only the tag data given by an unspecified large number of persons, it is not possible to treat each user flexibly depending on the record of using the contents, and provide flexibly the added value to each user.

An object of the invention is to provide a service system that can decide the equivalent value according to the record of using the contents by increasing not only a simple charge for using the contents but also the contents utility value and utilization rate, and collect the information for deciding the charge for using the added value valid for both the service provider and the service user to be higher for the service provider and cheaper for the service user.

Also, the invention desirably promotes the contents user to use the contents with higher utility value to attract the reader.

Also, the invention desirably enables the reader to properly obtain the desired information more simply from the perusal of the interesting contents.

Also, the invention desirably provides the interesting information of an unspecified large number of readers to the contents stock server users (customers) by collecting and arranging the interesting information of the readers.

Also, the invention desirably expands the scale of a contents stock business and obtains the equivalent value for the added value by collecting the providers or users through a scheme for providing the high added value photographic contents for the stock photo agency.

The present invention provides an interesting information creation method for registered contents, comprising a step of accepting input of one or more object areas from a terminal of a return information creator that is one or more users having authority for setting an object area that is any area within the contents to be a detection unit of position within the contents designated as an interesting target from a terminal of a general reader for the contents, and a step of registering the mask data associating one or more object areas inputted from the terminal of the return information creator with mask identification information that is an identification information for distinguishing the object area created by the return information creator for each return information creator in a contents stock database.

Preferably, the interesting information creation method for the registered contents further comprises a step of accepting input of return information corresponding to each of the object areas from the terminal of the return information creator, and a step of registering the return information corresponding to each of the object areas inputted from the terminal of the return information creator in the contents stock database.

Preferably, the interesting information creation method for the registered contents further comprises a step of detecting an object area corresponding to the position on the contents designated from the terminal of the general reader for each mask identification information.

Preferably, the interesting information creation method for the registered contents further comprises a step of extracting the return information corresponding to the detected object area from the contents stock database, and a step of transmitting the extracted return information to at least one of the terminal of the general reader designating any position in the contents, a terminal of a manager for the contents stock database, a terminal of a holder for the contents, and a terminal of a user for the contents.

Preferably, the interesting information creation method for the registered contents further comprises a step of receiving interesting point related information including at least one of the designated position on the contents, the identification information of the contents, the time when the object area of the contents is designated, the identification information of the general reader and an address of the terminal of the general reader from the terminal of the general reader, and a step of registering the interesting point related information in an interesting information database.

Preferably, in the interesting information creation method for the registered contents, the mask data is created individually corresponding to the identification information of each return information creator.

Preferably, in the interesting information creation method for the registered contents, the authority of the return information creator is given to at least one of a manager of the contents stock database, a holder of the contents and a user of the contents.

Preferably, the interesting information creation method for the registered contents further comprises a step of calculating equivalent value of using the contents to be imposed on a user of the contents in accordance with the designated number of object areas corresponding to the contents.

Preferably, the interesting information creation method for the registered contents further comprises a step of calculating equivalent value of providing the contents to be provided to a manager of the contents stock database, a user of the contents or a holder of the contents in accordance with the designated number of object areas corresponding to the contents.

Preferably, the interesting information creation method for the registered contents further comprises a step of providing the interesting point related information registered in the interesting information database to the terminal of the user with the predetermined access authority given.

Preferably, in the interesting information creation method for the registered contents, the user with the predetermined access authority given includes at least one of the manager of the interesting information database, the manager of a contents stock database, the holder of the contents, the user of the contents and the return information creator.

Preferably, the interesting information creation method for the registered contents further comprises a step of calculating the equivalent value of the interesting point related information or the totaled results of the interesting point related information.

The invention provides a contents stock server, comprising a device which accepts input of one or more object areas from a terminal of a return information creator that is one or more users having authority for setting an object area that is any area within contents to be a detection unit of position within the contents designated as an interesting target from a terminal of a general reader for the contents, a device which registers mask data associating one or more object areas inputted from the terminal of the return information creator with mask identification information that is an identification information for distinguishing the object area created by the return information creator for each return information creator in a contents stock database, a device which accepts input of return information corresponding to each of the object areas from the terminal of the return information creator, and a device that registers the return information corresponding to each of the object areas inputted from the terminal of the return information creator in the contents stock database.

Also, the invention provides a contents information management server comprising a device which accepts the designation of any position in the contents from a terminal of a general reader acquiring the contents by requesting transmission of the contents to a public server provided with the contents from the contents stock server, a device which detects the object area corresponding to the position designated from the terminal of the general reader for each object area described in object data corresponding to the different mask identification information, and a device which registers the interesting information associating the information indicating the designated position of the object area detected for each different mask identification information with the identification information of the detected object area in an interesting information database.

Also, the invention provides an interesting information creation system for registered contents, comprising the contents stock server, a device which accepts the designation of any position in the contents from a terminal of a general reader acquiring the contents from a public server provided with the contents from the contents stock server, and a device which detects the object area corresponding to the position designated from the terminal of the general reader for each object area described in the mask data corresponding to the different mask identification information.

The invention provides an interesting information creation method for the registered contents performed in a system having a terminal of a general reader for the contents, a terminal of a desired return information creator except for the terminal of the general reader, and a contents stock database, the method comprising a step of accepting input of one or more object areas from a terminal of a return information creator that is one or more users having authority for setting an object area that is any area within the contents to be a detection unit of the position within the contents designated as an interesting target from the terminal of the general reader for the contents, and a step of registering mask data associating one or more object areas inputted from the terminal of the return information creator with mask identification information that is an identification information for distinguishing the object area created by the return information creator for each return information creator in a contents stock database.

The invention provides an interesting information creation system for the registered contents comprising a terminal of a general reader for the contents, a terminal of a desired return information creator except for the terminal of the general reader, a contents stock database, a device which accepts input of one or more object areas from the terminal of the return information creator that is one or more users having authority for setting an object area that is any area within the contents to be a detection unit of position within the contents designated as an interesting target from the terminal of the general reader for the contents, and a device which registers mask data associating one or more object areas inputted from the terminal of the return information creator with mask identification information that is an identification information for distinguishing the object area created by the return information creator for each return information creator in a contents stock database.

With the invention, the contents user sets the object area associated with the mask identification information unique to the desired registered contents and counts the pieces of interesting information associating the information indicating the designated position of the object area detected for each mask identification information with the identification information of the detected object area, whereby it is possible to obtain the equivalent value according to the value of the contents, which is different from the simple charge for using the contents.

Also, since the different return information creators for the same contents can create individually the different mask data and return information, the interesting point of the same general reader for the same contents can be analyzed from the different viewpoint according to the mask data created by each person, whereby it is possible to provide the optimal interesting information to meet the demand of each of the contents reader, the contents holder, the contents user, the interesting information creator, and the contents stock agency.

### BRIEF DESCRIPTION OF THE DRAWINGS

FIG. 1 is a schematic configuration diagram of a contents management system;

FIGS. 2A to 2G are views showing the information stored in a contents stock database;

FIGS. 3A to 3H are views showing one example of an object (Layer);

FIGS. 4A to 4H are views showing one example of an object (Plane);

FIG. 5 is a view showing an object number in an example of FIGS. 4A to 4H;

FIG. 6 is a view showing one example of object information with the object number 0;

FIG. 7 is a view showing one example of object information with the object number 1;

FIG. 8 is a view showing one example of object information with the object number 2;

FIG. 9 is a view showing one example of object information with the object number 3;

FIG. 10 is a view showing one example of a contents basic information table in which the license information is updated;

FIGS. 11A and 11B are views showing one example of the object related information newly registered by an advertiser;

FIG. 12 is a view showing one example of the Web contents provided from a Web server;

FIG. 13 is a view showing a state with the mouse on the use contents within the Web contents;

FIG. 14 is a view showing a state of clicking on an interesting position of the use contents within the Web contents;

FIG. 15 is a view showing an object and its mask value;

FIG. 16 is a view showing the Web page displayed based on the link information associated with the object;

FIG. 17 is a view showing the Web page displayed with an Object Name associated with the object;

FIG. 18 is a view showing a state of displaying the totaled interesting positions superposed on the use contents; and

FIG. 19 is a schematic configuration diagram of a system to which the invention is applied.

### DETAILED DESCRIPTION OF THE PREFERRED EMBODIMENTS

The best mode for carrying out the present invention will be described below with reference to the accompanying drawings.

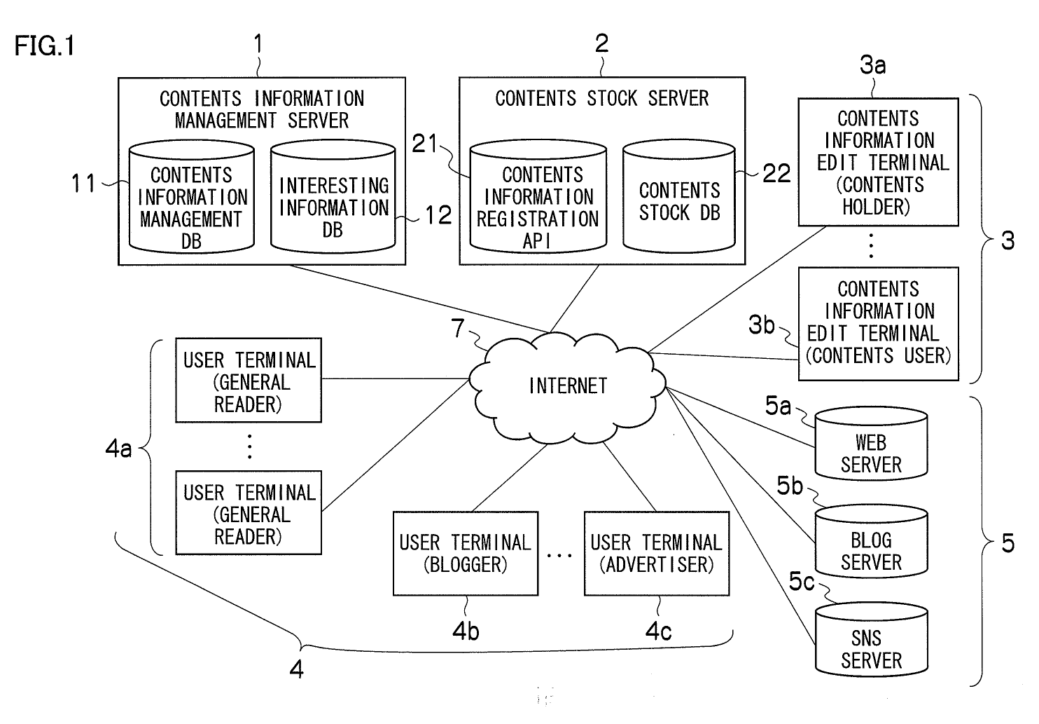

FIG. 1 shows a schematic configuration of a contents management system according to a preferred embodiment of the invention. This system comprises a contents information management server 1, a contents stock server 2, a contents information edit terminal 3 having a contents holder terminal 3a and a contents user terminal 3b, a user terminal 4 having a user terminal 4a of a general reader, a user terminal 4b of a blogger and a user terminal 4c of an advertiser, a contents providing server 5 having a Web server 5a, a blog server 5b, an SNS server 5c and so on, which are interconnected via the internet 7 and other communication lines. The contents information management server 1 and the contents stock server 2 are preferably separated in the physical configuration, but may be integrated. Also, the operators for both servers may or may not be the same.

Each of these servers or terminals is a personal computer comprising all or a part of an input operation device (keyboard, mouse or other pointing device, touch panel or the like), a display device (liquid crystal display or the like), a communication device (network card or the like), an information processing device (CPU, microcomputer or the like), a storage device (RAM, ROM, hard disk, CD-RW, or various other kinds of removable recording medium), and an information read/write device (CD-RW drive or the like).

### (1) Contents Upload/Contents Stock DB Registration

The contents holder (photographer, advertiser, or any other person who wants to have the contents used) first of all uploads the contents (reproduction data that can be transmitted or received via the network, and includes at least one of the still image and the motion picture, for example, photograph, illustration, movie and so on) to a contents stock DB 22 of the contents stock server 2, using the contents holder terminal 3a.

If the Web browser is started up at the information terminal (contents information edit terminal 3) such as a personal computer or PDA that is accessible to the internet 7 and the perusal is started with a predetermined URL (address of the server 2 to which the contents is uploaded) designated, the server 2 prompts the user to input a member ID and a password. If the user is not a member, the user is prompted to make a new member registration. It is required to gather the name, sex, date of birth, E-mail address, postal address and occupation in the profile registration.

And the information terminal is recognized by the contents holder terminal 3a and the server 2 through the log-in authentication based on the member information of the contents holder, and is enabled to use various functions as will be described later. One of the functions is a function of uploading the contents from the terminal 3a to the contents stock DB 22 via the network 7.

The contents are allocated a unique contents ID and registered, when uploaded to and registered in the contents stock DB 22.

Thereby, the registration of the information specifying the contents and the contents data main body in the contents stock DB 22 is once completed.

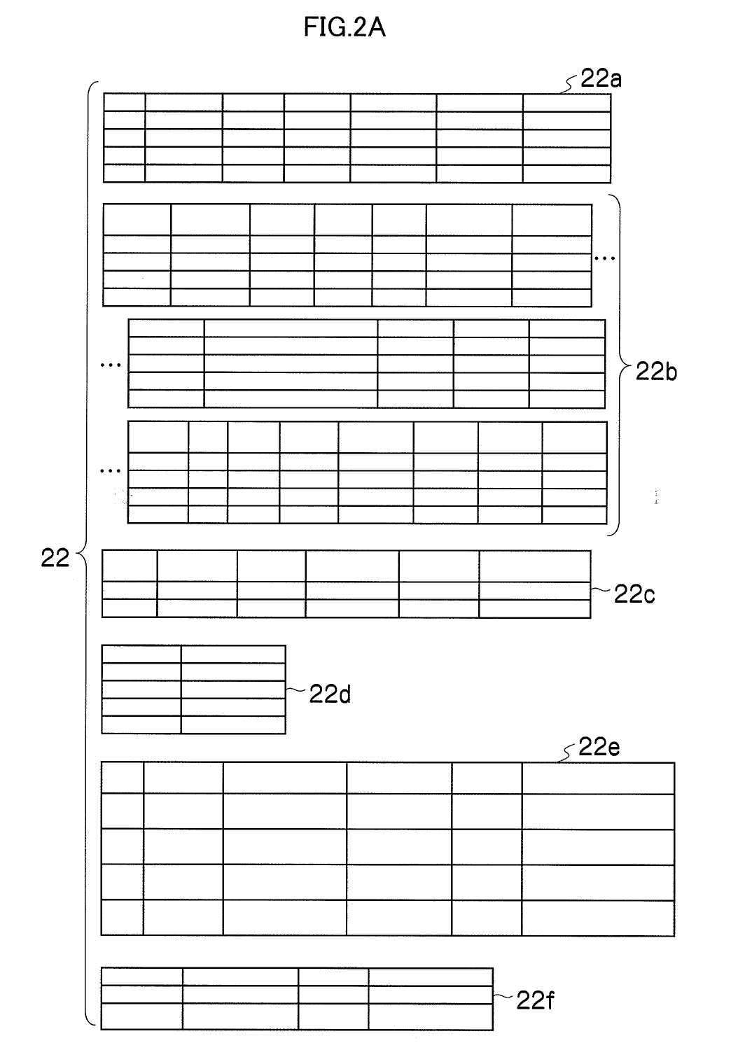

The contents stock DB 22 stores a contents main table 22a including associated the registration date, registrant (uniquely identifiable by the information such as an owner ID or member ID), a contents ID, contents data (original file name), and a thumbnail file name of the contents (automatically generated by the server 2 at the registration time), as shown in FIGS. 2A to 2G. Incidentally, FIG. 2A shows overall configuration of the content stock DB 22, and FIGS. 2B to 2G show examples of specific content of the content stock DB22.

### (2) Registering Contents Basic Information

Though the access restriction is imposed on the contents main table 22a registered in the contents stock DB to permit access for only the registered person oneself, the contents basic information is registered in a contents basic information table 22b to give the authority of access and search to the user terminal 4a of the general reader.

More specifically, if the Web browser on the personal computer is started up and a predetermined URL for access to the contents stock server 2 is inputted, the contents stock server 2 prompts the user to input the owner ID (member ID), whereby the user inputs it and logs in the server 2. Thereby, the personal computer is recognized as the contents holder terminal 3a by the contents stock server 2.

If a “stock photograph list” menu provided from the server 2 is designated at the terminal 3a, the contents registered in the contents stock DB 22 associated with one's owner ID (member ID) until now is displayed as a list at the user terminal 3a in an appreciable form of the combination of thumbnail image, contents ID and file name.

Thus, if the contents desired to input and edit the contents basic information is selected at the terminal 3a, and a “basic information input edit” button in the operation menu provided from the server 2 is pressed, a basic information input edit screen corresponding to the contents is opened, whereby the contents basic information is registered in accordance with the instructions on the screen. That is, the contents basic information is registered on the contents basic information edit screen by making access to the contents stock server 2 via the Web browser at the terminal 3a.

The contents basic information includes the contents kind information (contents file kind information, for example, JPEG/PS/MPEG-2), the contents substance basic information (category type, for example, report/landscape/portrait/sports, title, creation date, shooting location, search tag), and the right information (producer information, copyright information, portrait right information, use royalty condition information, public reference information and so on). By registering the contents basic information, these pieces of information are associated, and stored in the contents basic information table 22b of the contents stock DB 22.

With the input of them, in gaining access to the contents stock server to search the desired contents, the user can narrow down the candidate contents by selecting the category classification displayed on the Web browser or inputting a search keyword into a search text box.

### (2) Registering Object Information

The registration of object information will be described below in the case where the contents are photographic data. However, the contents are not necessarily photographic data, but may be motion picture data, character data or other graphic data.

The object means the physical object (e.g., subject such as a mountain, person or clothing) desired to be a detection object of the interesting information.

The contents registrant logs in the contents stock server 2 by performing a predetermined operation on the browser at various kinds of information terminal, and designates the “stock photograph list” to display a list of contents registered by oneself in the same way as above described. Thus, if the contents desired to input and edit the object information are selected, and the “object information input edit” button is pressed, the object information input edit screen is opened. On this object information input edit screen, a photographic screen for designating the object is largely displayed.

### (2-1) Setting the Object (Creating the Mask Data)

First of all, each contents holder decides the mask number (Mask No.) that is the identification number for designating the object information intrinsic to oneself. Herein, it is supposed that Mask No.=1 is designated.

Next, seeing the contents image, it is decided whether a single layer object for one contents can be designated (only on the surface) “Plane” or a multi-layered object for one contents can be designated (also in the depth direction) “Layer”. Any one of “Plane” and “Layer” can be selected and inputted on a mode selection screen provided from the server 2 to the terminal 3a.

Herein, the object of “Plane” and “Layer” can be identified by the 8-bit data.

That is, in the “Plane” designation, the object in which the mask value is any of 256(=2⁸) numerical values from 0 to 255 can be designated. On the other hand, in the “Layer” designation, the object in which the mask value is any of nine numerical values of 0, 1, 2, 4, 8, 16, 32, 64 and 128 can be designated. Of course, these objects may be identified by other data such as 16-bit data than 8-bit data. The mask value is the information for simply identifying the overlapping area between the objects.

The “Layer” permits the overlap of different objects, but has a merit that the interesting point of the general reader for each of the overlapping objects can be analyzed distinctively because the overlapping objects are distinguished by the mask value. On the other hand, for the “Plane”, the overlapping objects are not distinguished, but since more mask values are instead secured for the “Plane” at the same data capacity than for the “Layer”, more objects can be correspondingly set for the contents.

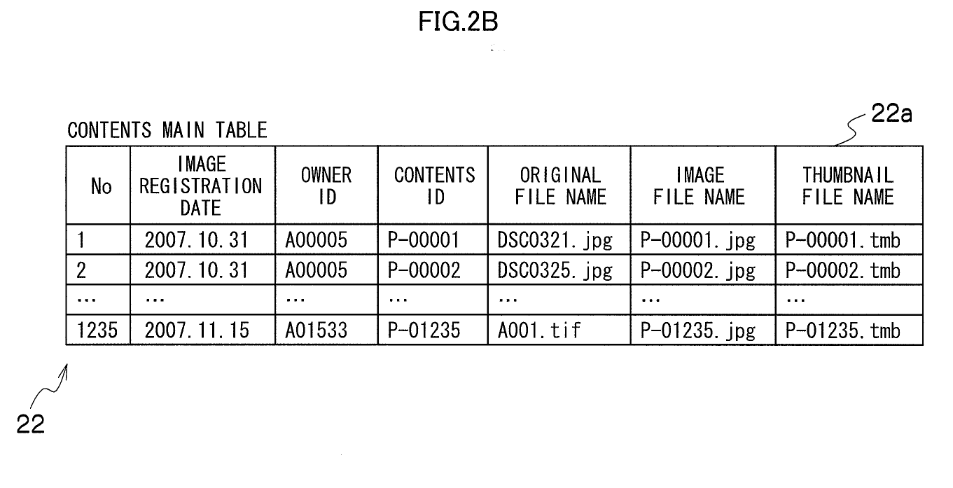

Herein, it is supposed that the “Layer” is selected. This state is an image in which a transparent (with the mask value of zero) layer as shown in FIG. 3B is superimposed on the photographic contents as shown in FIG. 3A.

Herein, in the case where the mask value “1” of the “Layer” is selected and a mountain, for example, is selected as the object on the photograph as shown in FIG. 3C, a subject area of the mountain is surrounded by the pointing device such as a mouse and its inside is selected. Then, the selected mask value “1” is allocated to the mask data in the selected area, as shown in FIG. 3D. With this mask value “1”, the subject area of the mountain is distinguished from all the simple background to which the mask value “0” is allocated.

Next, the mask value “2” is selected to select the human subject as the object and the shape of the human is surrounded to designate the inside area, as shown in FIG. 3E. The selected mask value “2” is allocated to the selected area in the shape of the human, as shown in FIG. 3F.

Next, the mask value “4” is selected to designate the clothing that the human subject wears as the object, and the part of the clothing is surrounded to designate the inside area, as shown in FIG. 3G. In this case, the area of the human and the area of the clothing overlap, whereby the mask value of “6” is allocated to the area of the clothing, because 2+4=6, as shown in FIG. 3H. Thereby, the bit string (00000110) of 8 bits indicating the mask value “6” (decimal) is “1” at the second bit and the third bit, in which “1” at the second bit indicates both the “human” area (mask value “2”=bit string 00000010) and the “clothing” area (mask value “4”=bit string 00000100), so that the human area, the clothing area and the overlapping area where the human area and the clothing area overlap can be identified by the mask values 2, 4 and 6, respectively.

In this way, the area of the mask value 0 can be defined as the background where no object is designated, and the area of the mask value 1 in which 1 is at the zeroth bit can be defined as the object of “mountain”. The area where eight objects overlap has mask data=255 (bit string 11111111). That is, in the data string of 8 bits, eight objects at maximum except for background=0, and a part or all of the overlapping areas can be represented. Needless to say, if the number of bits is increased, the maximum number of overlapping objects that can be represented is increased.

Since the contents stock server 2 visualizes the designated object superposed on the photographic contents by designating the mask number on the browser screen (e.g., FIGS. 3C, 3E and 3G show the cases where the mask number “1”, “2” and “4” are designated), the content holder can confirm whether or not the objects are orderly designated in accordance with the contents. Naturally, though the areas look like separate and isolated on the contents, even the object such as a detached territory that is identical as the actual physical object can be designated as the mask data of one target object.

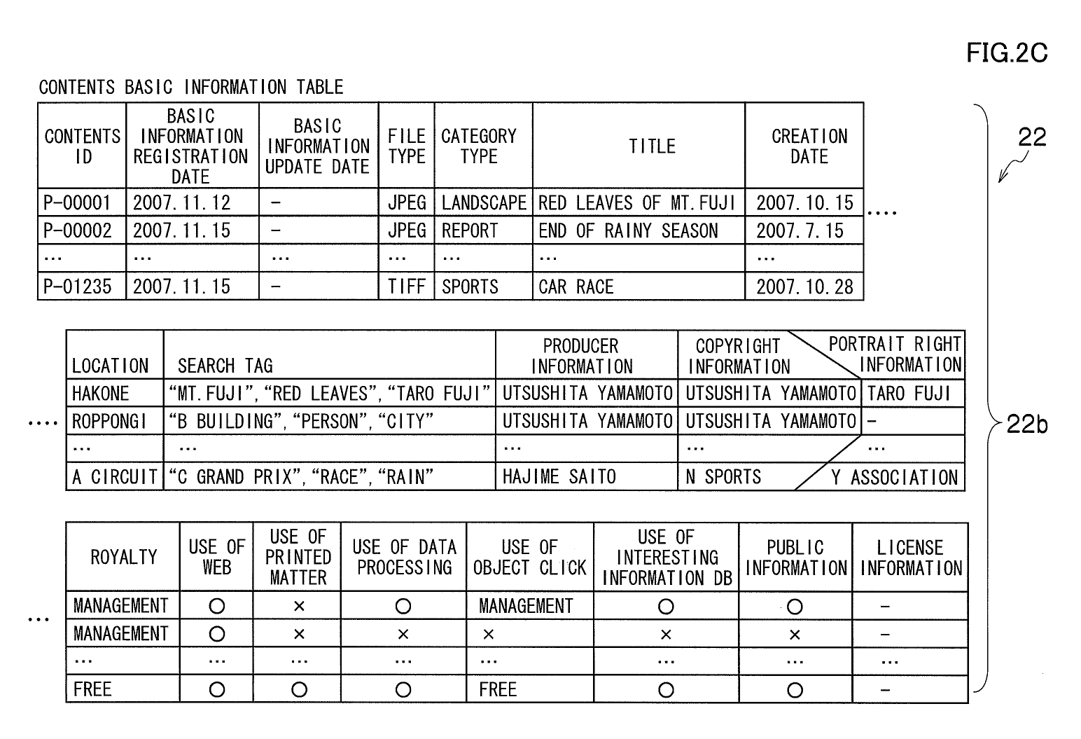

If the object designation is made as the “Plane”, the overlapping objects can not be defined, but 0-255 objects can be designated, including the background (=0) in FIGS. 4A and 4B. In designating the object, as the mask value is larger, the degree of priority is higher, whereby each object is set in consideration of the degree of priority, and in integrating the mask value of the finally set object, the mask value in the overlapping area of the objects is made the value of the larger mask value with higher degree of priority. In an example of FIGS. 4A to 4H, the body part (=2) and the clothing part (=3) overlap, but since the clothing part has higher degree of priority, in integrating the mask data, the mask data value of “3” is allocated to the clothing part (FIGS. 4G and 4H).

### (2-2) Setting the Object Number

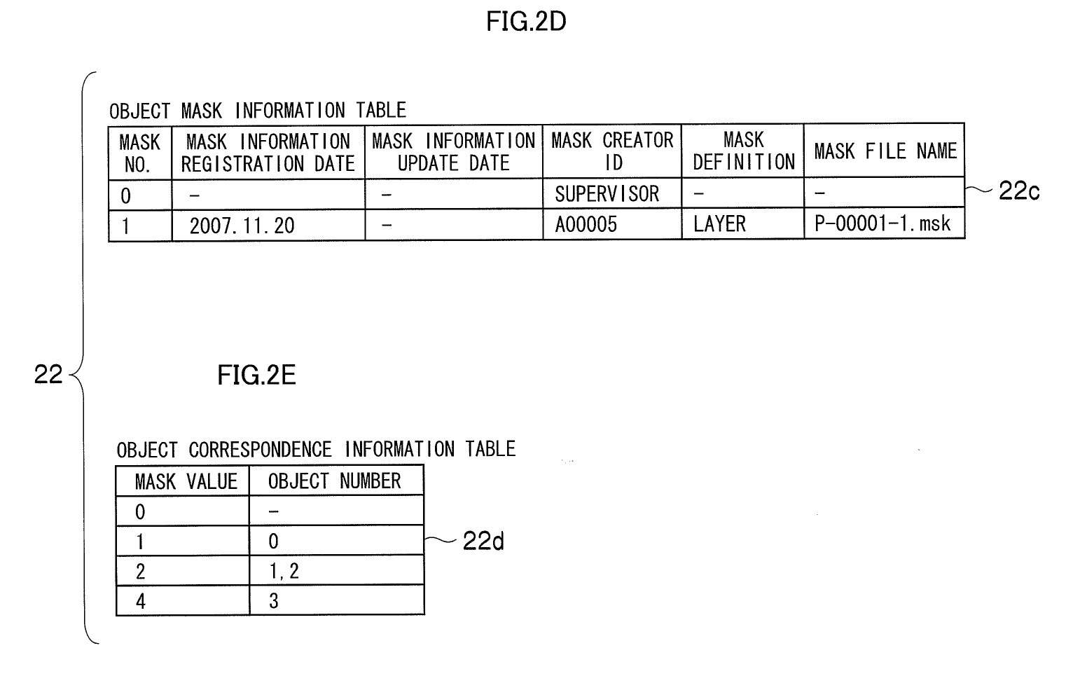

Next, the object number that is the identification information in search unit corresponding to the object set for each mask value is allocated. FIG. 5 shows the object number in the example of FIGS. 4A to 4H. In this example, the object is not set in the area of Mask(0) (mask value 0) where the background is supposed. In the area of Mask(1) that is the mountain, one object was set as Object(0). In the area of Mask(4) that is the clothing, Object(3) was set. In this example, four object targets are set. In the Plane mode, a plurality of object numbers can be also set for one object.

### (2-3) Setting the Object Information

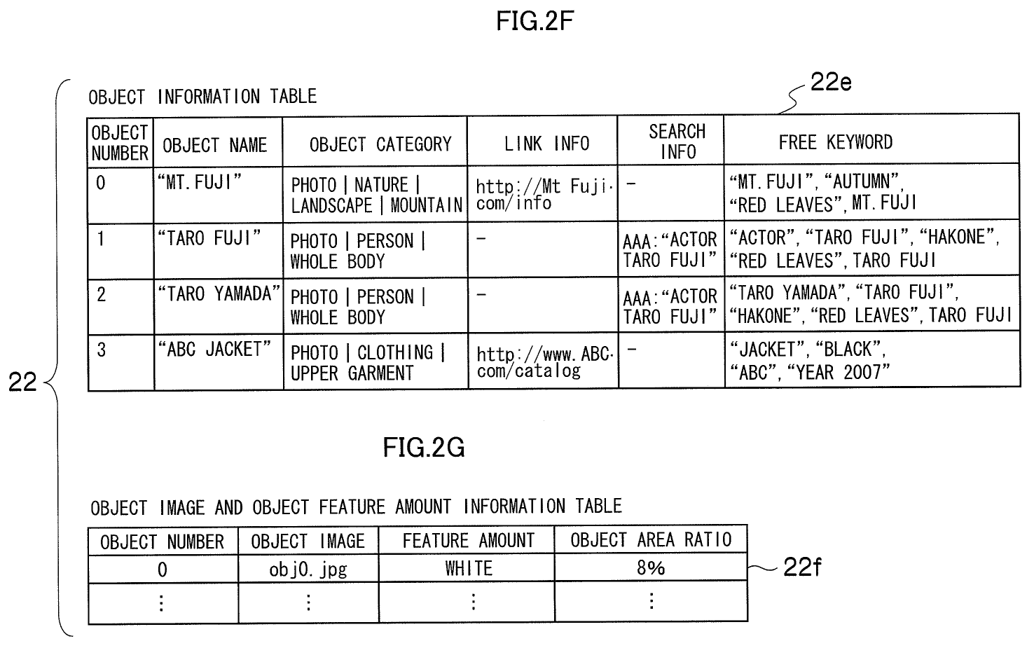

Next, an instance of setting the search information associated with each object number is shown. Object(0) is the mountain of “Mt. Fuji”, and the URL of Web information regarding it is registered in the Web page of http://Mt Fuji.com/info, whereby if the information is registered on the registration screen to link the information, the registration information in the contents stock DB 22 is prepared as shown in FIG. 6.

The registration information includes the object number, the object name, the object category, the search information and the keyword.

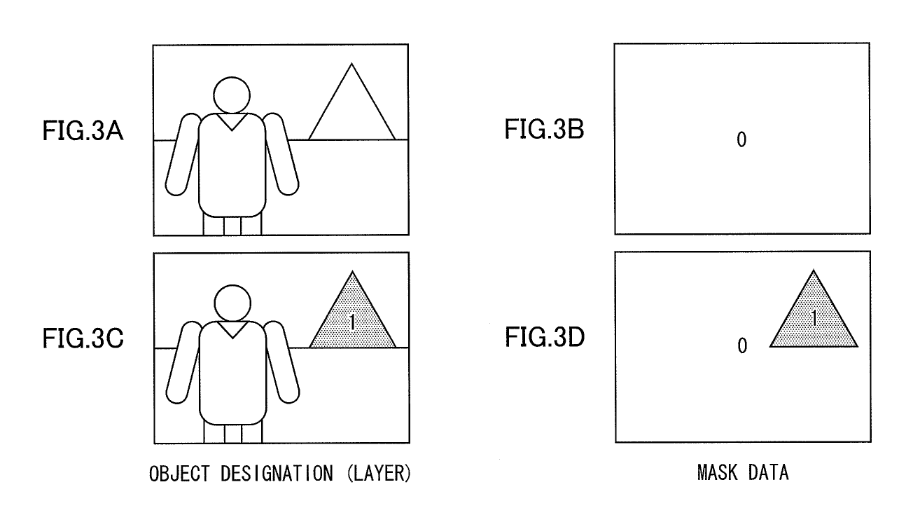

Similarly, Object(1) is the person with the stage name “Fuji Taro” (real name: Taro Yamada), and if the registration information to search the “actor Taro Fuji” as a search engine keyword regarding it using a search engine of AAA is inputted on the screen, the registration information in the contents stock DB 22 is prepared as shown in FIG. 7.

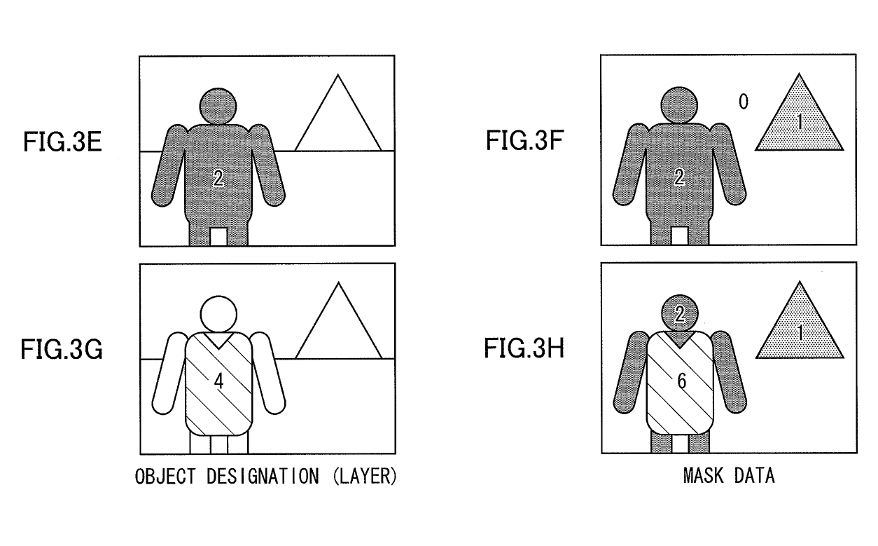

Since a plurality of object numbers can be associated with the same mask value, if the registration information is similarly inputted, the registration information in the contents stock DB 22 with Object (2) as another object of Object(1) is prepared as shown in FIG. 8.

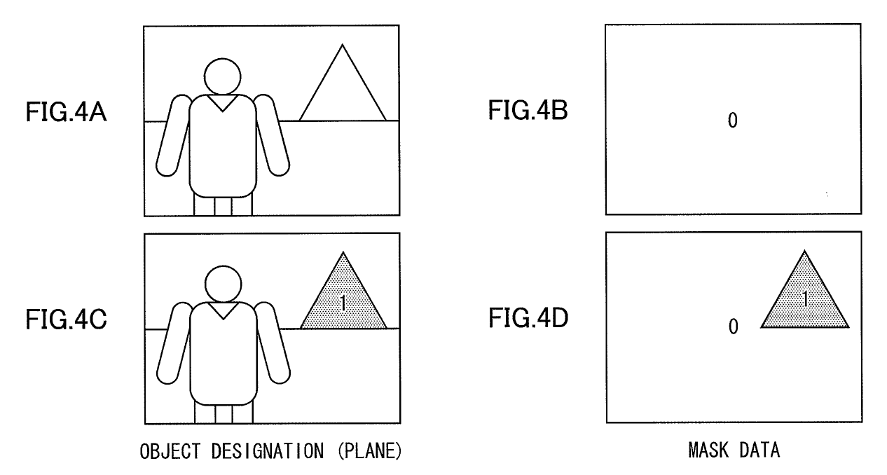

Similarly, the preparation for the registration information in the contents stock DB 22 is completed by inputting the registration information to be set for the object as shown in FIG. 9.

In the above way, since the preparation for the registration information is completed, a registration operation is performed in accordance with the instructions on the screen, so that an information registration process for the contents stock DB 22 is started.

More specifically, the contents stock server has the preparation for changing the data for the contents stock DB 22, and a mask file (P-00001-1.msk) with a part of the file name of the concerned contents ID (P-00001) is added to and edited in the record of the object mask information table 22c in the DB 22 corresponding to the mask number (Mask No.=1) that is a key of the registration information for each mask creator, as shown in FIGS. 2A and 2D. Also, the information indicating the correspondence between the mask value and the object number is added to and edited in an object correspondence information table 22d of the DB 22. Further, the object name, the object category, the link information (only when inputted), the search information (only when inputted), and the free keyword that are inputted for each object number are associated, and stored in an object information table 22e of the DB 22.

Referring to FIGS. 2A to 2G again, a structure of the contents stock DB 22 will be described below.

For example, in the record No. 1 of the contents main table 22a, if the member ID (contents owner) A0005 making the member registration with the contents stock service uploads the original image data of DSC0321.jpg to the contents stock DB 22 on Oct. 10, 2007, the contents stock server 2 gives the contents ID of P-00001 to the image data, and generates an image file of P-00001.jpg and an image of P-00001.tmb as its thumbnail image of to make the subsequent image handling convenient, completing the association.

The registration date is recorded as the current date and time generated by an RTC (real time clock) of the contents stock server 2 when uploading the original image is completed. The original file includes image data itself that the registrant uploads. Though the date is only indicated in FIGS. 2A to 2G, the time information (hour minute second) acquired from the clock information of the server is actually recorded. Other records are treated in the same way.

For the image file name, the original image file is read in the contents stock server 2, the required photographing data is extracted from the data (e.g., Exif data) recorded as meta-data in the original file if the original image file is opened without failure, and the meta-data required for the contents stock server is written as additional data into the image file. The original image file is stored without any processing. Also, this meta-data may be recorded as the necessary contents basic information in the corresponding record within the contents basic information table 22b, though not shown.

In an instance of the record No. 1235, the original image file is in a tiff format. If the tiff format can be accepted in this service, the original image is stored in the format as it is, whereby the contents stock server opens a tiff file and converts it into a jig file easy to handle in the subsequent service to make the image file.

Though the stock of file assuming the photograph (still image) has been exemplified in this embodiment, the motion picture file and other graphic reproduction files can be also stored in the contents stock server.

### (2-4) Contents Basic Information Table

The contents basic information table 22b of FIGS. 2A and 2C is the table in the DB 22 in which the basic information (file type, basic information, and right information) of the contents corresponding to the contents ID is registered. The contents basic information table 22b is configured with the contents ID as the main key.

The basic information registration date is recorded as the date and time when the information is registered in the contents basic information table. The basic information update date is recorded as the date and time when the registered data is modified or updated by calling the table 22b.

The file information type indicates the file format of the original image data.

The category type indicates the category classification of the contents based on the DB design. Preferably, a subcategory may be defined by subdividing the classification.

The title indicates the title of the contents, and is a search keyword with the highest priority in the contents search as will be described later.

The creation date indicates the so-called shooting date in the photograph, and if there is the Exif information, the shooting data is automatically inputted (manually changeable).

The location is inputted as the shooting location. Preferably, the GPS data is also inputted.

The search tag is the tag data inputted assuming the search keyword for searching the contents.

The producer information is the photographer information, for example, in the case of the photograph.

The copyright information indicates the copyright holder information of the contents.

The portrait right information indicates the information (such as the name of the person) regarding the right of portrait of the person reflected on the contents.

The royalty indicates the royalty condition for using the contents. The “management” indicates the condition for the contents owner managing the use of the contents by granting the limited license to the user.

The Web use and the printed matter use indicate the possibility of permitting the use on the Web or use on the printed matter by passing the data.

The data processing use indicates the possibility of permitting the data processing such as the partial trimming of the contents.

The object click use indicates the possibility of using the information providing system by the click operation on the Web contents by setting the object as will be described later.

The interesting information DB use indicates the possibility of using the service for distributing the interesting information registered in the interesting information DB 12 from the click point when the general reader (user of the user terminal 4a) clicks on the object of the contents, as will be described later.

The public information indicates whether or not the perusal of the contents within the contents stock server 2 is permitted by permitting the publication. At default, the “nonpublic” is set, and the contents can not be publicized until the publication permission is set in the contents basic information setting.

### (2-5) Object Mask Information Table

The object mask information table of FIGS. 2A and 2D is the table of the DB22 for arranging and storing the mask related information indicating the object of the contents corresponding to each contents ID.

In this embodiment, first of all, the contents owner ID=A00005 sets the mask related information. The mask No. is the number for specifying the mask (a plurality of masks can be set) to indicate a set of objects. The mask No.=0 is the mask used with privilege by the contents stock service agency that conducts this service. Thereby, the agency can set the mask data for all the contents and acquire the interesting information in accordance with the specifications unique to the interesting information DB 12.

In the example of FIG. 2D, since the contents owner ID A00005 registers the mask related information in the mask No. 1, the registration date, the creator and the mode definition (Layer mode in the example) of the created mask are registered in the line of the mask No. 1. The mask file indicating the substance of the object is registered as P-0001.msk. It is a point that a plurality of object masks and object information can be registered by a plurality of creators.

(2-6) Object Correspondence Information Table

In the object correspondence information table 22d as shown in FIGS. 2A and 2E, the number of target object corresponding to the mask value of the mask number for individually setting the object in the contents corresponding to each contents ID is registered.

Herein, the object is not set to the mask value 0. Object (0) is allocated to the mask value 1. Two objects of object (1) and object (2) are allocated to the mask value 2, and object (3) is allocated to the mask value 4 and registered.

### (2-7) Object Information Table

In the object information table 22e as shown in FIGS. 2A and 2F, the object information corresponding to the object number of the contents corresponding to each contents ID is registered. In this figure, the object information table corresponding to each object number of the object correspondence information table corresponding to the contents ID=P-00001 and the mask No.=1 is shown as one example. Each object information (Object Name, Category, Link Info, Search Info, Free Keyword) defined according to the object number 0-4 is registered.

### (2-8) Object Image/Object Feature Amount Information Table

In an object image/object feature amount information table 22f as shown in FIGS. 2A and 2G, the object image (image data within the rectangular area externally circumscribing the object image) and the image feature amount of the object image (lightness, chromaticity, saturation, contrast, shape feature, texture and so on) and the object area ratio (calculated as the ratio of the object area to the total area of contents) corresponding to the object number of the contents corresponding to each contents ID are registered.

If the object is registered from the terminal 3a (or terminal 3b), the contents stock server 2 automatically cuts out an image in the area corresponding to the registered object and analyzes the image, and registers the cut image data and the image feature amount and the object area ratio obtained as a result of the image analysis in this table.

With these tables in the contents stock DB 22, for example, the area of the clothing with the contents ID P-00001 gets to the Taro Fuji (stage name) that is the person defined as the object, Taro Yamada (real name), and the object related information allocated to the wearing jacket by tracing the correspondence relation of the table.

Also, since the feature amounts of image and the image data for the image of the object are registered in the DB22, with the feature amounts and the object information associated, they are used as the clustering processing data for the association between the similar images. For the kind of object information, various other items can be defined.

### (3) Using the Contents (From Search for the Contents to use of the Contents)

The user (e.g., advertiser already registered as the member) gains access to the contents stock server 2 from various kinds of information terminal and logs in using the ID (e.g., A00777) of the registered user to find a material photograph carried on the Web advertisement. Thereby, the information terminal is recognized as the contents user terminal 4c by the server 2. The contents search can be performed by inputting a keyword of “Mt. Fuji, red leaves, red”, for example, from the terminal 4c.

The contents stock server 2 searches the candidate contents in the contents basic information table 22b based on the input keyword from the terminal 3b (using various kinds of information such as category type, title, creation date, location, search tag, producer information, copyright information and portrait right information registered in the contents stock DB22 as the search key), and displays the candidate contents image on the Web browser screen of the terminal 4c. In this example, Mt. Fuji, red leaves, and red as the keyword are searched, and the contents with greater red tendency are preferentially searched from the image feature amounts.

And the user is interested in the P-00001 contents, for example, and checks various conditions (for example, whether or not the use conditions are met with the use purpose) to decide the use.

In this case, if a “use” button is pressed on the Web browser screen in which P-00001 is selected, the contents stock server 2 permits this user (e.g., A00777) to use the P-00001 contents. Though the details are omitted, the service contract is concluded by confirming the consent for the use conditions or inputting the liquidation charging information.

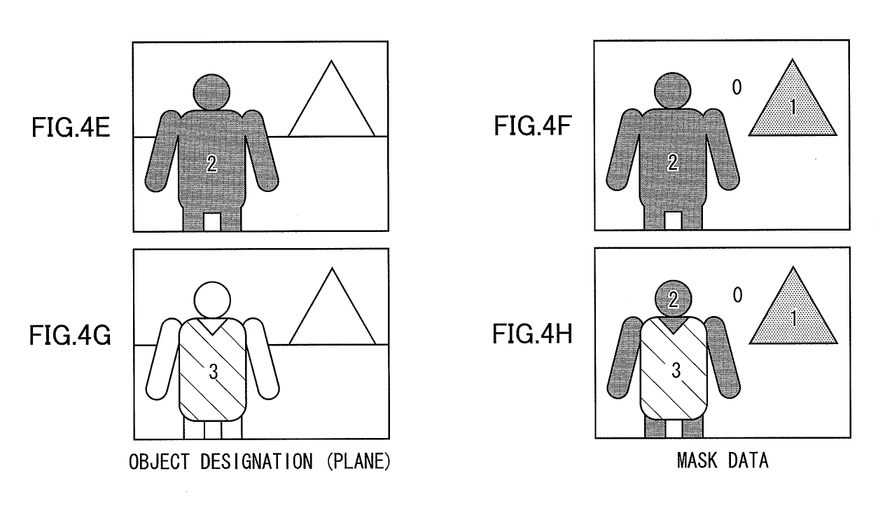

If the contract is concluded, the member ID (e.g., A00777) of this user is registered in the user consent information corresponding to the contents ID P-00001 in the table 22b, as shown in FIG. 10.

Under the registration conditions of this table 22b, the A00777 member can process and use the contents on the Web under the conditions that the Web can be used, the printed matter can not be used (accordingly the contents data itself can not be downloaded), the data can be processed, the object click can be used under the managed conditions, and the interesting information DB 12 can be used (the interesting information accumulated in the interesting information DB 12 can be acquired and perused) in this contract.

And if the object related information addition possible, for example, is specified (already set in the details setting in the DB item, though not shown) under the management conditions for using the object click in the DB item as above mentioned, the object related information according to one's purpose can be set by changing the image size for using the Web, for example.

Thus, the object related information for the P-00001 contents can be changed at the contents information edit terminal 3a (which may be the same hardware as the advertiser terminal 4c).

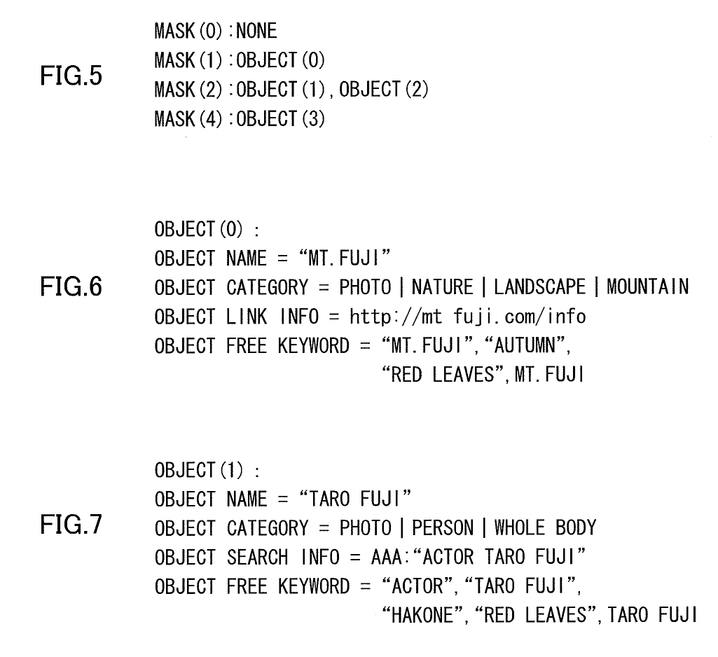

More specifically, the object related information registration may be newly set by performing the same operation as the object related information registration. For example, the object related information can be newly registered as shown in FIGS. 11A and 11B.

If the object information setting is completed, the registration operation is performed by designating a predetermined image size (e.g., 640×480) to be carried on the Web page for using the Web.

Through this work, the contents of the original size (e.g., 3872×2592) is scaled up or down to the predetermined image size (e.g., 640×480), and stored in a predetermined directory folder for storing the Web perusal image. Also, each master data with the contents area designated is stored as a master data file for Web perusal image (e.g., file such as C-00001.jpg or C-00001-1.msk) through this scale up or down process. And this master data is set as the master data for click action in an active state.

And a script file for Web perusal is generated. If this script file for Web perusal is arranged in the Web page file, the Web browser is programmed to read and interpret the script file to perform a predetermined operation by plug-in. More specifically, the C-00001.jpg image is displayed at a predetermined position of the Web page. If the mouse is on the image, it is checked whether or not the object setting is made by communicating with the contents management information server. If the object setting is made, a skin “Click on the interesting point in the image” is displayed. Clicking on the interesting point, the unique ID of this image file is acquired, and the information with the address information at the click point packed is transmitted to the contents management information server. The script file with these functions programmed is created beforehand and distributed from the server 5 to the user terminal 4a.

Next, the Web perusal image data/Web perusal master data/object information data are set in the contents management information server 1.

Using this scheme, for example, if the advertiser registers the photograph to be advertised in the advertisement as the contents in the contents stock server, registers the object related information of the object (or plural objects) to be advertised, and registers a contents script file for material with the title for material such as “for blog” or “for SNS” attached to the search keyword in the contents stock server 2 under the royalty free contents conditions, the blogger downloads the interesting contents script in it to the terminal 4a, and pastes the contents script file with the blog article such as commodity introduction to one's blog (stored in the blog server 5b) or the SNS page (stored in the SNS server 5c).

Thereby, when the general reader peruses the blog, the information (e.g., incitement to a predetermined Web page) that the advertiser wants to provide can be provided by clicking on the object target with the mouse on the contents expanded over the blog page.

Contents perusal (providing the information to the general reader—coalition of the contents information management server)

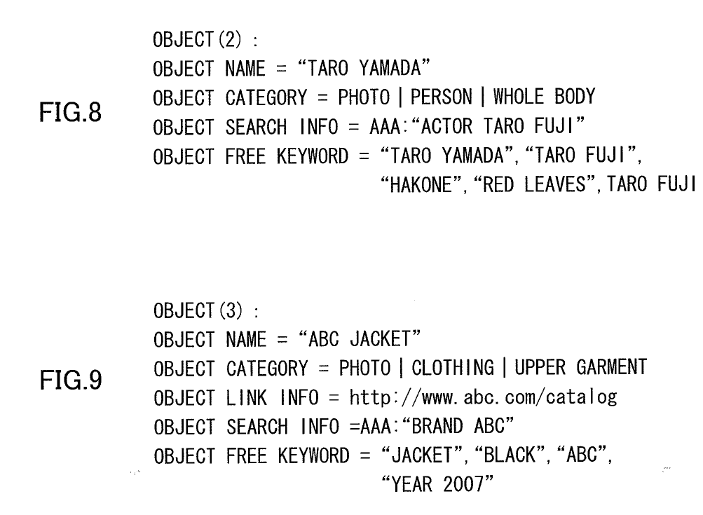

The general reader starts up the Web browser and designates the transmission of a Web page at a predetermined URL address (e.g., http://ZZZ.jp/yyy) at the terminal 4a, the browser interprets the source data described in the URL address, and requests the transmission of this Web page to the Web server 5a. As a result, a screen is displayed on the browser, as shown in FIG. 12. Though the details are omitted, the article contents composed of text data and the photographic image contents (registered in the contents basic information table 22b) based on the interpretation of the contents script file are displayed in this Web page.

As described above, a program part for firstly downloading the image contents data from the storage address (such as a specific directory within the contents stock DB22 of the contents stock server 2) of the Web perusal image data (C-00001.jpg) in the image contents and instructing the terminal 4a to display the image contents at a predetermined position in the browser is executed in this contents script file, whereby the contents image is displayed at the terminal 4a.

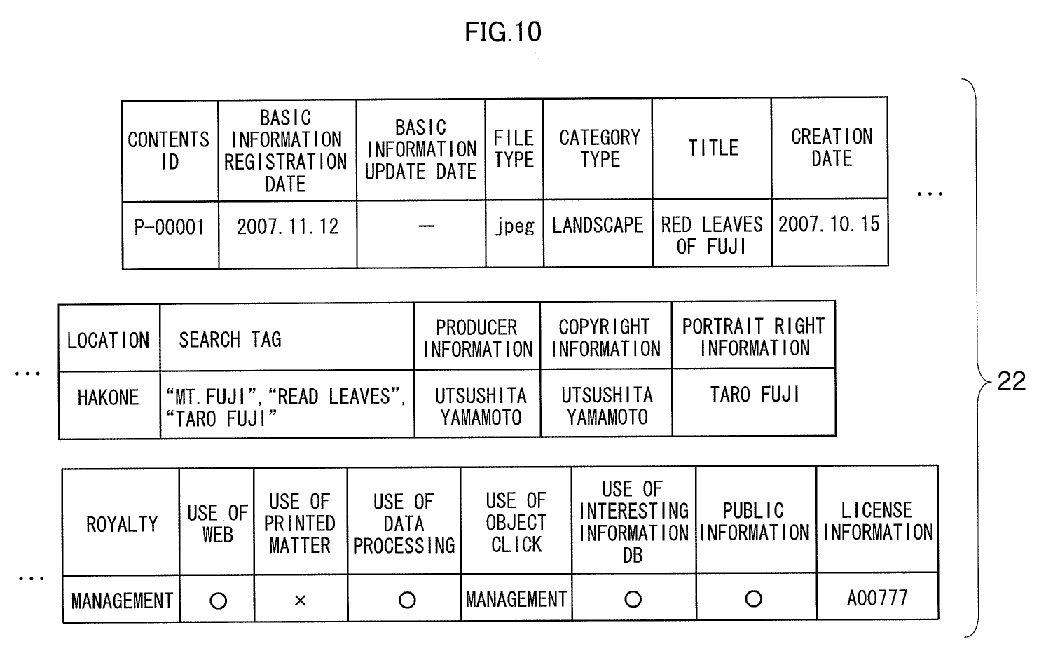

If the reader, interested in the photograph, mouses (places) the pointer on the contents image as shown in FIG. 13, a program part of the script program for displaying the skin (display for the user) on the contents image is executed, whereby a message such as “Click on an interesting location” is displayed. That is, this message is not the substance itself of the Web contents but is displayed by skin execution of the script program in response to on-mouse.

In the above example, the photographer uploads the contents from the terminal 3a to the contents stock server 2, and the contents user such as the advertiser searches this contents to be used at the user terminal 4c, makes a service contract of paying the royalty as the contents user, and retrieves and uses the contents in one's Web site opened in the Web server 5a under the conditions. In the following, an instance of perusing the Web site at the terminal 4a of the general reader for the contents, and obtaining the reply offering information by clicking on the contents is shown. The reply offering information is not only returned to the terminal 4a of the general reader, but also may be transmitted to the manager terminal of the contents stock database, not shown, the contents holder terminal 3a or the contents user terminals 3b, 4b and 4c.

To summarize, if the contents reader designates the interesting point on the contents from the terminal 4a, the terminal 4a transmits the interesting point related information including the information on the interesting point (contents ID, contents click address and so on) to the contents information management server 1 and the contents stock server 2, and makes an inquiry to the contents stock DB 22 for the presence or absence of the reply offering information corresponding to the interesting point related information.

The contents information management server 1 stores the interesting point related information received from the terminal 4a in the interesting information DB 12.

The contents stock server 2 searches the contents stock DB 22 for the reply offering information corresponding to the interesting point related information transmitted thereto, and if there is the applicable reply offering information, the reply offering information is returned to the terminal 4a. The reply offering information may be transmitted to not only the terminal 4a but also the contents information management server 1. In this case, the received reply offering information and the interesting point related information are associated and stored as one interesting information in the interesting information DB 12.

More specifically, at least one reply offering information creator (contents holder, contents user, contents stock agency, other persons having the authority for generating and registering the reply offering information on the desired contents in the contents stock DB 22, except for the general reader) sets the substance (Link Info, Object Category, Object Name and so on) of the object information table 22e corresponding to the desired contents as the reply offering information, and returns the reply offering information upon receiving the interesting point related information corresponding to the contents.

Since a plurality of reply offering information creators can independently register the reply offering information corresponding to the specific contents of the contents stock DB 22, the general reader should activate a plurality of perusal pages in receiving the reply offering information with designation and inquiry of the interesting point in the specific contents from the terminal 4a, if there are plural pieces of provider information. In this way, the contents reader can acquire more interesting information without exception.

Of course, if too many pieces of interesting information are transmitted at once, the general reader may be confused to handle them, whereby if the number of reply offering information corresponding to the interesting point is more than a certain number, the general reader is prompted to input a confirmation as to whether or not to transmit it, and only if the confirmation input is made, the interesting information may be transmitted. Or the general reader may input a status setting to receive the interesting information created by the specific reply offering information creator or refuse the reception from the terminal 4a into the contents stock DB 22.

If the object of Layer is set, and an overlapping portion of a plurality of objects is designated as the interesting point, all the reply offering information corresponding to each of the overlapping objects is returned. For example, if there is an overlapping area of the mask value “6” where a human body area of the mask value “2” and a clothing area of the mask value “4” overlap and the click point is designated within the overlapping area, both the reply offering information (such as Object Name “Taro Fuji”) corresponding to the clothing area and the reply offering information (such as Object Name “ABC jacket”) corresponding to the human body area are returned.

If the object of Plane is set, the plurality of objects do not overlap, whereby the reply offering information corresponding to the object including the interesting point is directly returned.

That is, if a certain interesting point of the contents is clicked, the object (Layer or Plane) including the interesting point in the contents is specified individually for each mask creator ID and each mask No., the reply offering information corresponding to each specified object is further specified, and all (or part) of the specified reply offering information is returned to the general reader. If there are a number of mask creators, the reply offering information is accordingly increased, and further if the object of Layer is created, the reply offering information is increased if there are more overlapping objects.

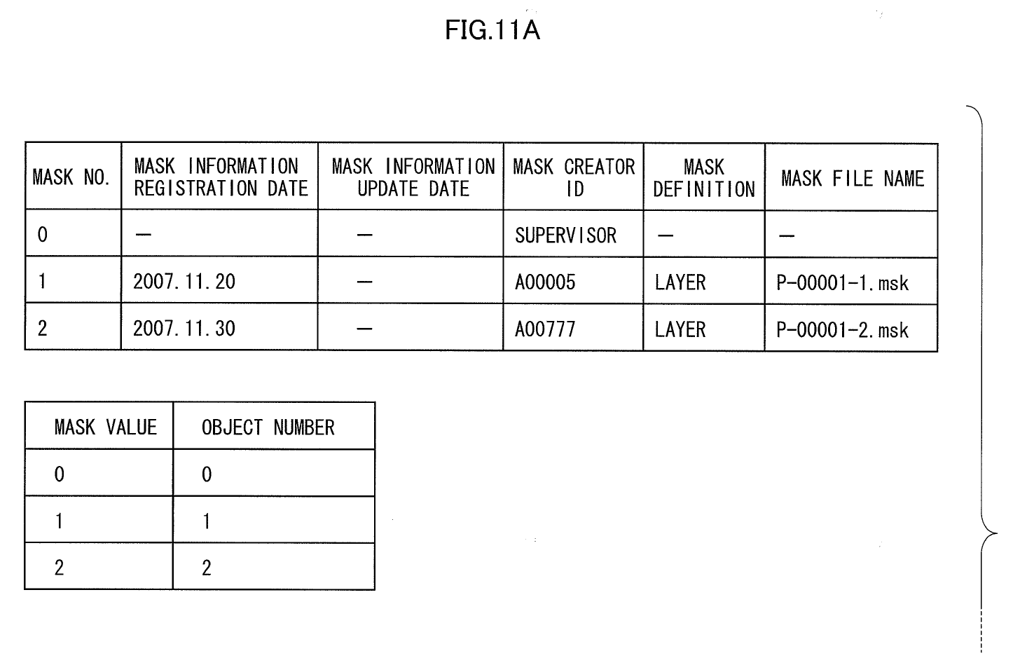

For example, first of all, the general reader, who is interested in the jacket of photograph, clicks on the position of jacket with the pointing device of the terminal 4a, as shown in FIG. 14. If clicked, a program part that monitors the operation of the pointer with the script being operated at the terminal 4a acquires the clicked position information, converts it into the address information on the photographic contents and transmits the address information along with the contents ID information for specifying this photographic contents to the contents information management server 1. The interesting point related information actually transmitted by the script of the terminal 4a includes the contents ID, the contents click address, the contents click time, the Web page URL, the contents user ID, the IP address information, and the reader information (member ID and so on), if possible.

The contents click time can be acquired from an RTC (real time clock) contained in the terminal 4a. If this time is incorrect and less reliable, the time when the contents information management server 1 receives the interesting point related information may be substituted.

The Web page URL is acquired from an address input column of the web browser at the terminal 4a.

The contents user ID is embedded beforehand into the contents by the reply offering information creator in creating the reply offering information. When the contents reader peruses the contents and clicks on the interesting point, the concerned ID is taken from the contents and incorporated into the interesting point related information.

The IP address information is the IP address of the terminal 4a, and can be acquired by analyzing the packet information of the interesting point related information. In the case where the IP address of the terminal 4a is dynamically allocated by the internet provider, the IP address may be changed every time the internet connection of the terminal 4a is disconnected, but for an inquiry from the terminal 4a for the period without disconnection, it is one element capable of specifying that the reader who is the user of the terminal 4a is identical or one element capable of specifying the subscribing provider.

If the general reader is the member of the content stock agency, and the member ID is registered in the contents stock DB 22, the general reader can be specified by transmitting the member ID from the terminal 4a.

These interesting point related information becomes the useful information (when, how and what the reader is interested in) for the contents holder, the contents user, the contents stock agency, and other persons who create the interesting information for the contents as hereinafter described by combining it with the information as to where in the contents the reader is interested in.

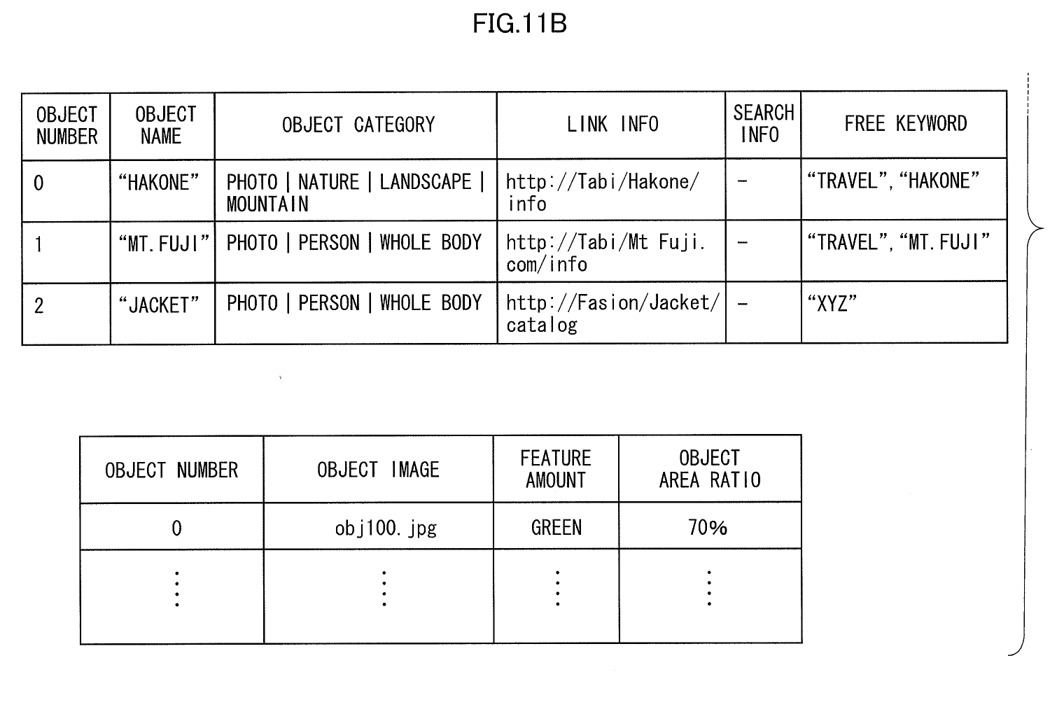

The contents information management server 1 calls the contents basic information and the mask related information with the mask No.=2 corresponding to the contents ID (P-00001) and the advertiser ID (A00777), and acquires the mask value of the address point on the mask image. It is assumed that the mask value corresponding to the mouse designated position of FIG. 14 is “2” as shown in FIG. 15. Naturally, the acquired mask value even for the same contents is different for each ID of the contents user. For example, even if the interesting point of FIG. 14 is designated, the mask value defined by the mask No.=1 corresponding to the contents ID (P-00001) and the ID (A0005) of the contents user is “6” (see FIG. 3H).

The user of this contents defines and creates the mask data with the mask No.=2 for this contents, and sets the object numbers of the background counterpart (0), the mountain part (1) and the clothing part (2) (see FIGS. 11A and 11B), whereby for the click portion (indicating the clicked address with x), it is possible to extract Object (2) as the object corresponding to the interesting point (FIG. 15). Thus, the related information of Object (2) from the applicable table is searched from the object information table 22e, and extracts “http://Fashion/Jacket/catalog (information stored in Link Info) as the reply offering information to the reader. The data is returned as the answer information to the browser at the terminal 4a of the general reader.

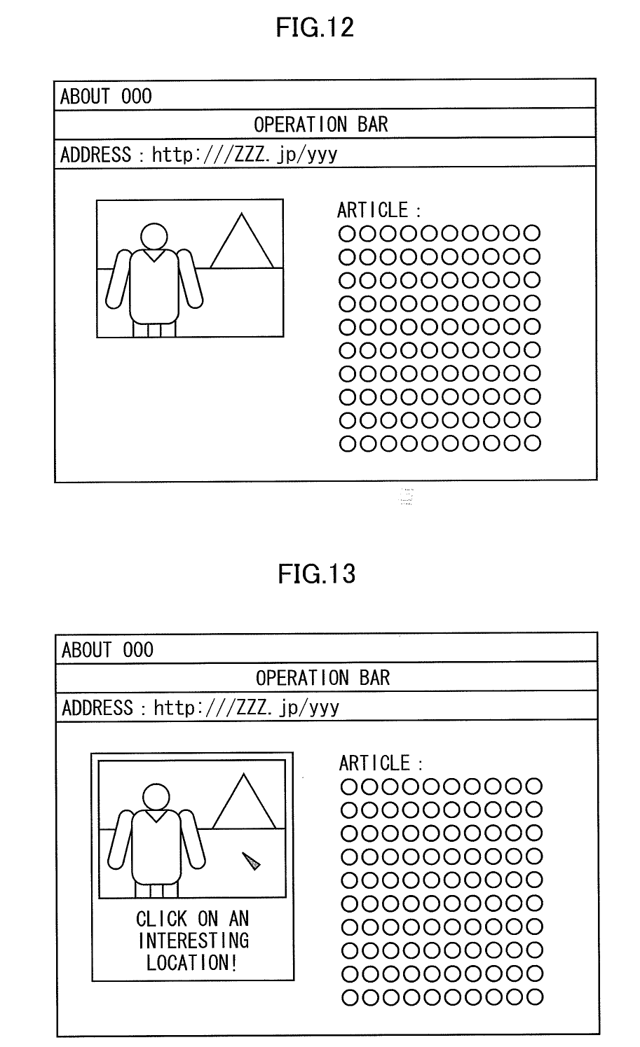

The browser displays the applicable Web page from the returned URL address “http://Fashion/Jacket/catalog” as shown in FIG. 16. If a plurality of pieces of Link Info are returned as a plurality of pieces of reply offering information, the browser displays each of a plurality of Web pages corresponding to the plurality of pieces of Link Info.

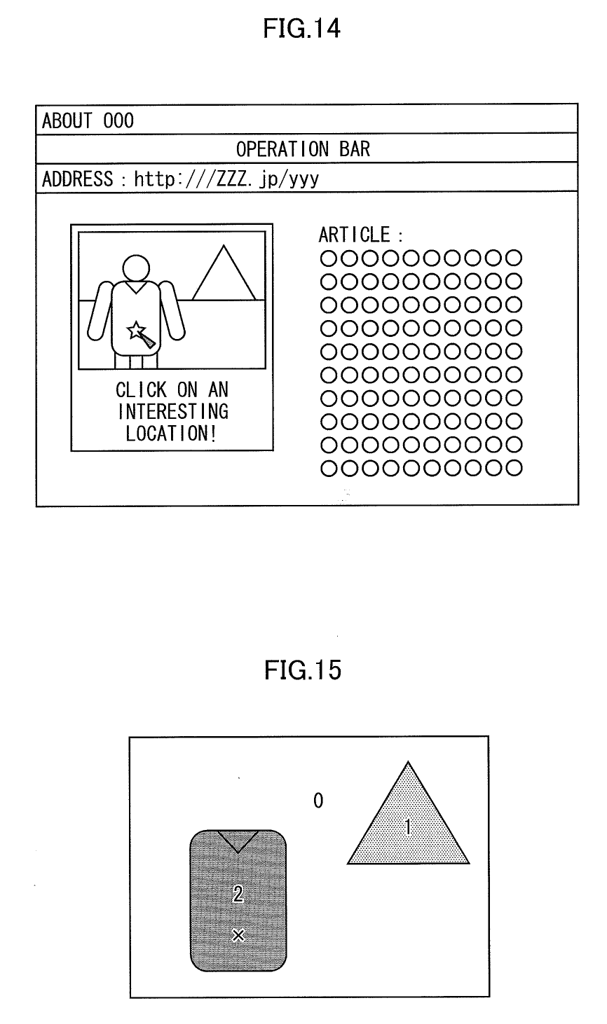

More preferably, the mouse address data of on mouse is transmitted in real time to the content stock server 2 with a program of script file, and a part or all of the object related information in the object information table 22e is returned to the terminal 4a. For example, the Object Name “Hakone” corresponding to the object number 0 in the object information table of FIG. 11B is returned, and the Object Name “Hakone” corresponding to the object number (=0) pointed to on the screen is displayed beside as shown in FIG. 17. If the on mouse position by the reader is the information that the reader is actually interested in, the mouse is clicked and the reply offering information (Link Info) is returned for the first time at that moment, whereby only the reply offering information that the reader is really interested in can be transmitted efficiently.

The click information (perused contents ID, click address of the contents, contents click date and time, perusal Web page URL, contents user ID, IP address information of the terminal 4a, and general reader information (such as member ID of the general reader) if possible) of the general reader is transmitted to the contents information management server 1, and stored in an inquiry table (not shown) of the contents information management server 1.

The mask data for specifying the object in which the contents user (registrant) is different for each contents and the object related information according to the object specified by the mask data are registered in the contents information management server 1.

For the interesting information DB 12 within the contents information management server 1, the interesting information table for each contents is created by managing and totaling the click information in the inquiry table including the action results of the interest of the reader for each object information registrant and registered in the interesting information DB 12.

Thereby, the user (e.g., contents holder or contents user) who has access permission for each contents can analyze the interest of the reader for the contents permitted for the user.

For example, for this contents (contents ID=P-00001), the contents registrant (member ID=A00005), the contents user (member ID=A00777), the stock agency (member ID=supervisor) are permitted to gain access to the interesting information DB 12 regarding this contents, and, the total of the interesting points (number of clicks) of the reader is displayed as a list for each contents permitted for each member in this embodiment. Thereby, which contents the reader is interested in can be grasped individually for each different object registered by the different contents user.

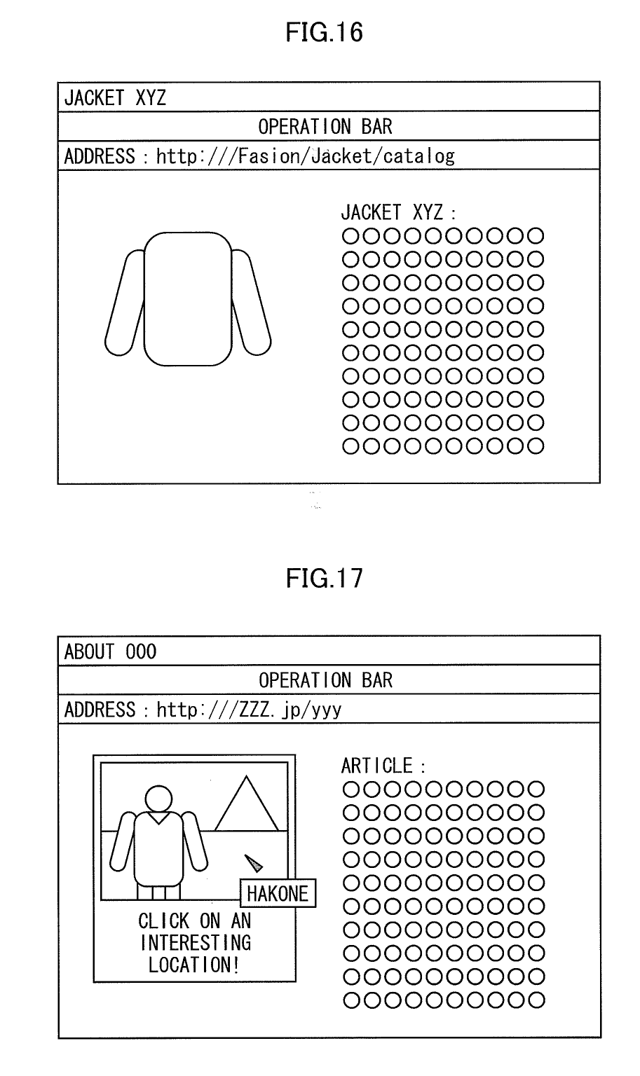

Next, the contents information management server 1 creates an image in which the contents image and the click point are superposed for the contents that the reader is interested in and provides it to the terminal 4c of the contents user, as shown in FIG. 18. Perusing this superposed image, the reader can confirm which part of the object set by oneself is interested in for the contents selected by oneself.

In this figure, the click point (interesting point) recorded within the inquiry table is plotted onto the corresponding contents image. Herein, it can be found that an unspecified large number of general readers are mainly interested in the person (clothing) and mountain of the contents image.

Since the object of “Layer” permits the duplication, the number of interesting points within the duplicate area of the objects corresponding to the different mask values is counted doubly. For example, in the mask data of FIGS. 3A to 3H, there is a duplicate area of the mask value “6” where the human body area of the mask value “2” and the clothing area of the mask value “4” are duplicated, in which the click point within the duplicate area is totaled as the click point of the clothing area, and also totaled as the click point of the human body area. As a result, totaling the click points in FIG. 18, the total number of clicks in the clothing area is 8 and the total number of clicks in the human body area is 8(total number of clicks in the duplicate area)+5(total number of clicks in the unduplicated area)=13.

Since the object of “Plane” does not permit the duplication, the number of interesting points within the duplicate area corresponding to the different mask values is not counted. For example, totaling the click points in FIG. 18, the total number of clicks in the clothing area is 8 and the total number of clicks in the human body area is 5.

The contents information management server 1 calculates the total number of clicks according to the definition of Layer and Plane, and appropriately provides the interesting information analysis results to the terminal of the return information creator. The equivalent value according to the number of providing the totaled results may be calculated, and charged or billed to the terminal of the return information creator. The equivalent value as referred to in this specification is converted based on the money or its substitutes (card charge, point, electronic money and so on).

Also, the person who has access permission to the interesting information DB 12 can acquire the interesting information corresponding to the object set by oneself, because the object information is set independently of the interesting information DB 12.

For example, the member ID=A00005 sets three objects of Object number 1, 2 and 3 as the interesting object areas with the mask No.=1, attaches the meaning of the objects to the items of Object Name, Object Category, Link Info, Search Info and Free Keyword, and counts the number of clicks for each object number or the number of clicks for each meaning. Thereby, if the charge for use according to the total number of contents clicks by the general reader is set in the service contract for licensing the advertiser (member ID=00777), the equivalent value according to the contents value different from the simple charge for use of the contents can be obtained by counting the number of clicks.

That is, if the general reader does not click on the contents selected by the advertiser at all, or the number of clicks is small, the contents are less visible by the general reader and have a low value as the advertisement media, and in such a case, the charge for use is low, whereby the advertiser do not need to pay unnecessary costs for the advertisement media with low value. Conversely, if the click is concentrated on the contents selected by the advertiser, the contents have a high value as the advertisement media, and in such a case, the charge for use is high, whereby the contents provider can obtain a proper recompense by providing the contents with high value.

Also, since the information of which Web page the reader clicks on is included in each click point, it is possible to check whether or not the contents are used correctly by checking the Web page. Though the contents are used by one advertiser in this embodiment, even if the contents are used by a plurality of advertisers, it is possible to check and manage individually which user uses the contents from which Web page, because the Web page address information or contents user ID can be specified.

Besides, it is possible to confirm what contents or object the reader is interested in by individually analyzing the number of counts from each contents for the keyword set by the reader.

For the advertiser (member ID=00777), the reader can jump to the attractive Web page by clicking on the subject area, and confirm the effect of using this contents by counting the number of clicks for the object.

For example, if the advertiser registers the photograph to be diffused in the advertisement as the contents in the contents stock server 2, registers the object related information of the object (plural objects) to be advertised, attaches the title for material such as “for blog” or “for SNS” to the search keyword under the royalty free contents conditions, and registers the contents script file for material in the contents stock server 2, the reader downloads the interested contents script and pastes the contents script file together with the article of blog such as commodity introduction to one's blog (stored in the blog server 5b) or SNS page (stored in the SNS server 5c).

Thereby, when the general reader peruses the blog, the information (e.g., incitement to a predetermined Web page) that the advertiser wants to provide can be provided by clicking on the object target with the mouse on the contents expanded over the blog page.

The stock agency itself can analyze the interesting information collected in the interesting information DB 12 broadly from the stock contents with the “supervisor” authority to analyze the interesting information of the reader by the agency itself, and analyze and process the data to broadly provide the business information to the customer.

As one example, various kinds of settings including the object information setting as the “supervisor” are not made at the present time to the contents (contents ID=P-00001) in this embodiment, but if the valuable contents are judged by analyzing the access information of the interesting information DB 12 as described previously, the interesting information analysis for the reader can be made by setting the object information ex post facto.

The contents holder, the contents user, the contents stock agency and other persons who define the mask for the contents or create the reply offering information can grasp the trend of interest in the contents of the general reader and make effective use of it for the services in the future with reference to the interesting point related information or reply offering information transmitted in response to clicking by the user.

It is optional how each person makes use of the interesting point related information in the interesting information DB 12. The contents holder can transmit the reply offering information to the contents reader, as needed, and can grasp which of the held contents the reader is interested in at the click position of the contents by analyzing the interesting point related information received from the general reader. Or the contents or the object area is tagged by analyzing the interesting area, and used to raise the search rank of the held contents. Also, the contents use situation of each contents user can be grasped, the equivalent value of use according to the number of contents clicks can be charged to the contents user. Or the Web page URL is perused, and checked to see whether or not the contents are used under the licensed conditions to confirm whether or not the contents are illegally used.

The contents user has the propaganda contents from the contents holder such as the advertiser carried on the Web page or the like owned by the user under the contents use conditions by analyzing the interesting point related information from the general reader, and can confirm the results that the contents reader is interested in the carried contents by perusing one's home page, blog or SNS and clicks from the interesting information DB 12. Thereby, it is possible to confirm the information for obtaining an affiliate recompense from the advertiser.

The contents stock agency can obtain the use situation (access situation to the reply offering information) of the stocked contents. As an intermediation between the contents holder and the contents user, the contents stock agency can conduct a collection and delivery business for the equivalent value of using the contents by grasping the use situation of the reply offering information, and also conduct a business for receiving by oneself an appropriate compensation (charge for use) from the equivalent value.

Further, the additional compensation can be obtained from the customer (in this case, not limited to the contents holder or the contents user) by analyzing and arranging the interesting information accumulated in the interesting information DB 12, and selling the resultant data.

Also, the destination of transmitting the reply offering information is not necessarily limited to the terminal 4a of the general reader, as described above, but the reply offering information may be also returned to the terminal 3a of the contents holder and the terminals 3b, 4b and 4c of the contents user.

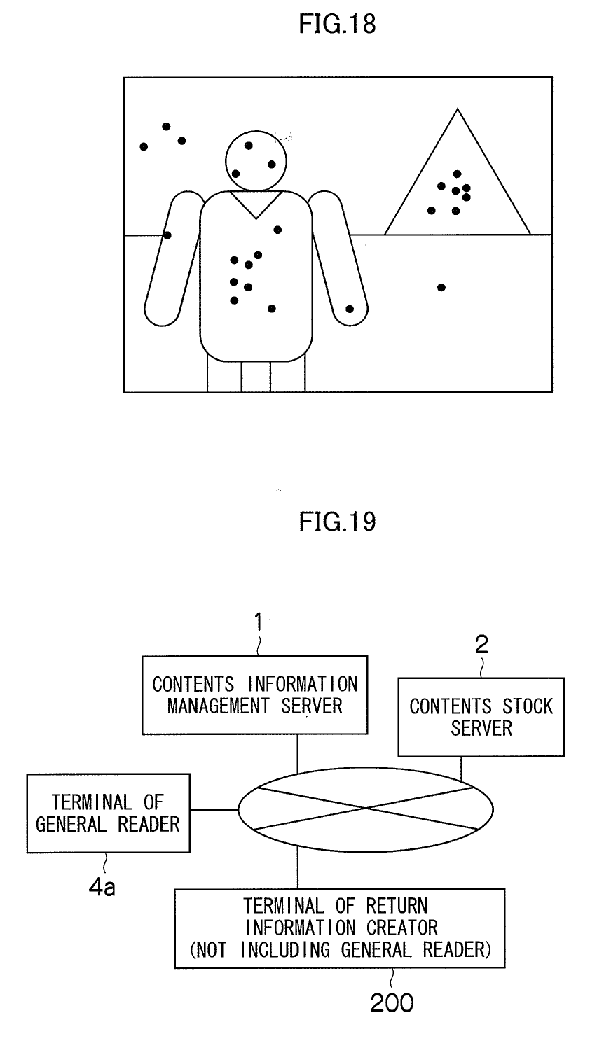

The essential point of this invention resides in the system comprising the contents information management server 1, the contents stock server 2, the general reader terminal 4a, and the terminal 200 of the person having the authority for setting the object and reply offering information (e.g., the contents information edit terminal 3, the blogger terminal 4b, the advertiser terminal 4c or the contents providing server 5 as shown in FIG. 1) except for the general reader, as shown in FIG. 19, in which the mask data and the corresponding reply offering information can be individually registered in the contents stock DB 22 of the contents stock server 2 for each authorized person from the terminal 200, and if any position of the contents is designated from the terminal 4a of the general reader, the information indicating the designated position or the interesting position related information such as the click time is stored in the interesting information DB 12 of the contents information management server 1, and the reply offering information (registered individually for each authorized person) associated with the object including the designated position is transmitted to the terminal 4a of the general reader, the interesting information DB 12 of the contents information management server 1 or the terminal 200. A difference between the general reader and the other persons is the authority for setting the object and reply offering information, not the destination of transmitting the reply offering information.

What is claimed is:

1. An interesting information creation method for registered contents, comprising:
a step of accepting input of one or more object areas from a terminal of a return information creator that is one or more users having authority for setting an object area that is any area within the contents to be a detection unit of position within the contents designated as an interesting target from a terminal of a general reader for the contents; and
a step of registering mask data associating one or more object areas inputted from the terminal of the return information creator with mask identification information that is an identification information for distinguishing the object area created by the return information creator for each return information creator in a contents stock database.

2. The interesting information creation method for the registered contents according to claim 1, further comprising:
a step of accepting input of return information corresponding to each of the object areas from the terminal of the return information creator; and
a step of registering the return information corresponding to each of the object areas inputted from the terminal of the return information creator in the contents stock database.

3. The interesting information creation method for the registered contents according to claim 2, further comprising a step of detecting an object area corresponding to the position on the contents designated from the terminal of the general reader for each mask identification information.

4. The interesting information creation method for the registered contents according to claim 3, further comprising:
a step of extracting return information corresponding to the detected object area from the contents stock database; and
a step of transmitting the extracted return information to at least one of the terminal of the general reader designating any position in the contents, a terminal of a manager for the contents stock database, a terminal of a holder for the contents, and a terminal of a user for the contents.

5. The interesting information creation method for the registered contents according to claim 4, further comprising:
a step of receiving interesting point related information including at least one of the designated position on the contents, the identification information of the contents, the time when the object area of the contents is designated, the identification information of the general reader and address of the terminal of the general reader from the terminal of the general reader; and
a step of registering the interesting point related information in an interesting information database.

6. The interesting information creation method for the registered contents according to claim 1, wherein the mask data is created individually corresponding to the identification information of each return information creator.

7. The interesting information creation method for the registered contents according to claim 1, wherein the authority of the return information creator is given to at least one of a manager of the contents stock database, a holder of the contents and a user of the contents.

8. The interesting information creation method for the registered contents according to claim 1, further comprising a step of calculating equivalent value of using the contents to be imposed on a user of the contents in accordance with the designated number of object areas corresponding to the contents.

9. The interesting information creation method for the registered contents according to claim 1, further comprising a step of calculating equivalent value of providing the contents to be provided to a manager of the contents stock database, a user of the contents or a holder of the contents in accordance with the designated number of object areas corresponding to the contents.

10. The interesting information creation method for the registered contents according to claim 5, further comprising a step of providing the interesting point related information registered in the interesting information database or totaled results of the interesting point related information to the terminal of the user with the predetermined access authority given.

11. The interesting information creation method for the registered contents according to claim 10, wherein the user with the predetermined access authority given includes at least one of the manager of the interesting information database, the manager of the contents stock database, the holder of the contents, the user of the contents and the return information creator.

12. The interesting information creation method for the registered contents according to claim 10, further comprising a step of calculating equivalent value of the interesting point related information or the totaled results of the interesting point related information.

13. A contents stock server, comprising:
a device which accepts input of one or more object areas from a terminal of a return information creator that is one or more users having authority for setting an object area that is any area within contents to be a detection unit of position within the contents designated as an interesting target from a terminal of a general reader for the contents;
a device which registers mask data associating one or more object areas inputted from the terminal of the return information creator with mask identification information that is an identification information for distinguishing the object area created by the return information creator for each return information creator in a contents stock database;
a device which accepts input of return information corresponding to each of the object areas from the terminal of the return information creator; and
a device which registers the return information corresponding to each of the object areas inputted from the terminal of the return information creator in the contents stock database.

14. A contents information management server comprising:
a device which accepts designation of any position in the contents from a terminal of a general reader acquiring the contents by requesting transmission of the contents to a public server provided with the contents from the contents stock server according to claim 13;
a device which detects object area corresponding to the position designated from the terminal of the general reader for each object area described in object data corresponding to the different mask identification information; and
a device which registers interesting information associating information indicating the designated position of the object area detected for each different mask identification information with identification information of the detected object area in an interesting information database.

15. An interesting information creation system for registered contents, comprising:
the contents stock server according to claim 13;
a device which accepts designation of any position in the contents from a terminal of a general reader acquiring the contents from a public server provided with the contents from the contents stock server; and
a device which detects the object area corresponding to the position designated from the terminal of the general reader for each object area described in the mask data corresponding to the different mask identification information.

16. An interesting information creation method for registered contents performed in a system having a terminal of a general reader for the contents, a terminal of a desired return information creator except for the terminal of the general reader, and a contents stock database, the method comprising:
a step of accepting input of one or more object areas from a terminal of a return information creator that is one or more users having authority for setting an object area that is any area within the contents to be a detection unit of the position within the contents designated as an interesting target from the terminal of the general reader for the contents; and
a step of registering mask data associating one or more object areas inputted from the terminal of the return information creator with mask identification information that is an identification information for distinguishing the object area created by the return information creator for each return information creator in a contents stock database.

17. An interesting information creation system for registered contents comprising:
a terminal of a general reader for the contents;
a terminal of a desired return information creator except for the terminal of the general reader;
a contents stock database;
a device which accepts input of one or more object areas from the terminal of the return information creator that is one or more users having authority for setting an object area that is any area within the contents to be a detection unit of position within the contents designated as an interesting target from the terminal of the general reader for the contents; and
a device which registers mask data associating one or more object areas inputted from the terminal of the return information creator with mask identification information that is the identification information for distinguishing the object area created by the return information creator for each return information creator in a contents stock database.
